(19) United States
(12) Patent Application Publication
(10) Pub. No.: US 2026/0094446 A1
(43) Pub. Date: Apr. 2, 2026

(54) FRICTIONLESS ITEM IDENTIFICATION IN RETAIL

(71) Applicant: Digimarc Corporation, Beaverton, OR (US)

(72) Inventors: Eric D. Evans, Portland, OR (US); Tony F. Rodriguez, Portland, OR (US)

(21) Appl. No.: 19/343,839

(22) Filed: Sep. 29, 2025

Related U.S. Application Data
(60) Provisional application No. 63/700,009, filed on Sep. 27, 2024.

(51) Int. Cl. G06V 20/52; G06V 10/143; G06V 10/26; G06V 10/764; G06V 10/82; H04N 23/90

(52) U.S. Cl. CPC G06V 20/52; G06V 10/143; G06V 10/26; G06V 10/764; G06V 10/82; H04N 23/90

(57) ABSTRACT

A frictionless checkout system identifies items in retail transactions using multiple cameras and image processing. Ceiling-, bagging area- and/or shelf-mounted cameras capture video frames of items in a shopping cart from different perspectives to form an initial list of items associated with a shopper. A bagging-area camera captures video frames as items are removed from the cart and placed into bags. An image processing system, comprising object segmentation, digital watermark reading, and complementary methods such as barcode detection and object recognition, identifies the items and updates a transaction tally. Prior to unloading, the system maintains a global state of items and their positions in the cart. As items are removed, changes in this state are detected and verified at the bagging area. The system provides real-time identification, reduces manual scanning, and generates alerts when items detected in the cart are not added to the transaction tally.

### RELATED APPLICATION DATA

This application claims the benefit of U.S. Provisional Patent Application No. 63/700,009, filed Sep. 27, 2024, which is hereby incorporated herein by reference in its entirety.

### TECHNICAL FIELD

The invention relates to image capture apparatus and processing for item identification in retail operations.

### BACKGROUND OF THE INVENTION

Advances in signal processing, sensors, and computing capability have reduced friction in the shopping experience by speeding or even eliminating the traditional checkout experience. The improvements in the capability of cameras and computing power, along with advances in object recognition and machine learning offer the potential to identify items with little or no manual scanning of items for checkout. These innovations have also improved the efficiency of retail operations, reducing labor costs and loss of inventory. Even with the advances in machine learning and GPU computing capability, the reliability of probabilistic identification methods, e.g., those that rely on trained models for object classification and recognition are insufficient, as they do not achieve the necessary detection accuracy within the constraints of the application.

In our earlier work, we addressed these challenges, in part, by combining the power of deterministic identification methods, including barcode and digital watermark reading, with probabilistic methods for object recognition and classification. This innovation improves accuracy and lowers cost by leveraging multiple sensors and fusing the output of item and shopper event data to provide more complete and reliable identification of items selected by a shopper. This reliability is critical to instilling shopper trust, providing reliable loss prevention, and enhancing retailer reputation. See U.S. Pat. No. 11,763,113 and PCT Publication WO2024054784, which are hereby incorporated by reference.

Several challenges remain in implementing these technologies in a cost effective and scalable manner. While sensor and computing capabilities continue to progress rapidly, the latest cameras and computing power, including GPUs, needed to capture and process high quality video data are often still not practical and cost effective for wide-scale adoption within retail stores. To reduce cost and processing complexity, it is necessary to limit the number of cameras and image data processing required. However, using fewer cameras reduces reliability as it reduces the ability to see and accurately identify items, particularly if items are occluded by other objects or the shopper.

Digital watermarking is advantageous as it enables items to be identified, even if only a portion of an item is visible to a camera because the digital watermark is redundant on the packaging surface. This enables versatile configurations in which a camera can be used to capture images of items within carts or baskets, in checkout lanes, and around item bagging and checkout stations. When included within these configurations, a digital watermark reader provides reliable identification of the items, even if partially occluded, while obviating the need for a manual scanning operation.

Digital watermark-based identification is effective when used alone and makes multi-mode identification methods more powerful. It broadens the versatility and reliability of item identification, enabling new frictionless checkout and loss prevention methods and system designs. To fully leverage these benefits, system design must enhance image capture across varying distances and lighting conditions, while remaining cost effective to scale across retail environments. Additionally, advancements in image processing are required to accurately identify items at a distance, even in the presence of object occlusions and quality degradations like motion blur and poor lighting.

### SUMMARY OF THE INVENTION

This specification describes systems and methods for friction-less item identification in retail. One aspect of the invention is a system for identifying items for a retail checkout process. The system comprises cameras that capture video frames of items in a shopping cart or basket from different perspectives to develop an initial list of items associated with a shopper. The system further comprises a bagging station camera that captures video frames of items as they move from the cart or basket to a bagging area. As items are identified in the bagging station, the system updates a tally for a shopping transaction.

The system includes a computer configured with image processing programs to identify items in the cart. The programs include object segmentation, digital watermarking, and complementary item identification methods, such as barcode reading and object recognition, using trained classifiers. Prior to unloading the cart, the system has a global state of items and their positions in the cart. Then, as items are removed, the system detects removal of items based on changes in this state and identifies items as they enter the bagging station.

The system performs object segmentation on the video frames of the shopping cart to produce bounding regions of items. It then seeks to read digital watermarks and barcodes from these bounding regions. When it identifies items, it records identifiers for them and their locations in the global state of items in the cart. Complementary image recognition is also performed to expand the recognition of items in the cart.

At the bagging station, the system performs real time digital watermark reading and complementary object recognition on video frames as items are removed from the cart and moved into a bagging station. The system provides a frictionless shopping experience, reducing or eliminating manual scanning, and providing loss prevention by generating an alert when items identified in the cart are not added to the tally.

Additional aspects of the invention include image capture configurations, image processing methods for item identification, and methods for aggregating outputs of the item identification processes to provide a reliable tally for a shopping transaction.

Additional inventive features will become apparent from the following detailed description and accompanying claims.

### BRIEF DESCRIPTION OF DRAWINGS

FIGS. 1A-C depict a side, end, and top-down view of a configuration of cameras for capturing images of items in a shopping cart or basket from above. The side-view of FIG. 1A illustrates the field of view of the cameras spanning the front and back section of the cart.

FIGS. 2A-C depict another configuration of cameras for capturing images of items in a shopping cart from the side of the cart.

FIGS. 3A-B depict camera configurations for capturing images of items in the bottom of a shopping cart. FIG. 3A is a top-down view of single and two-camera configurations. FIG. 3B is an end-view of the single camera configuration of FIG. 3A.

FIGS. 4A-C illustrate side, end, and top-down views of another camera configuration for capturing images of items in a shopping cart.

FIGS. 5A-C illustrate side, end, and top-down views of another camera configuration.

FIG. 6 illustrates a camera and lighting configuration for capturing images in a bagging station.

FIG. 7 is a flow diagram illustrating a method for identifying items selected by a shopper prior to check-out.

FIG. 8 is a flow diagram illustrating a method for identifying items in a bagging area.

FIG. 9 is a diagram of an exemplary computing environment used to implement aspects of the invention.

### DETAILED DESCRIPTION OF THE INVENTION

This detailed description begins with a description of the image capture configurations for frictionless item identification in retail. This includes capture of image of items in a cart, including bottom of basket, as well as items as they transit from the cart to bagging. We then describe methods for frictionless item identification, employing these configurations.

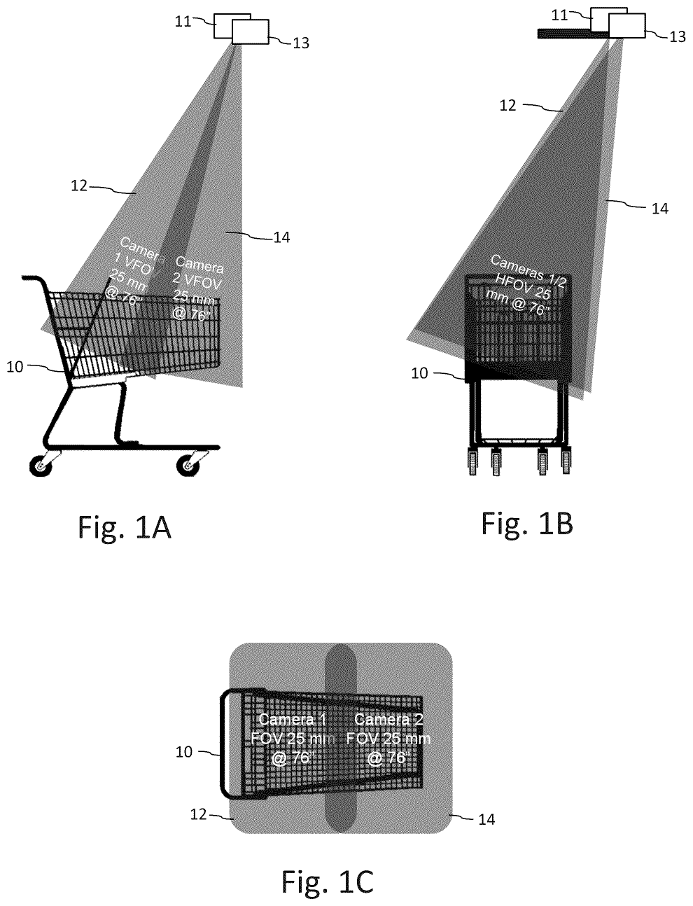

FIGS. 1A-C depict a side, end, and top-down view of a configuration of cameras for capturing images of items in a shopping cart (10) from above. The side-view of FIG. 1A illustrates the field of view (FOV) (12, 14) of two cameras (camera 1 (11) and camera 2 (13)) spanning the front and back section of the cart. The abbreviations V and H in VFOV and HFOV refer to vertical and horizontal FOV, respectively, and together form the three-dimensional viewing volume of the cameras.

This configuration is intended to facilitate frictionless checkout by identifying items in the cart via image capture from top-down cameras, without requiring manual scanning of barcodes. To be inobtrusive to the shopping experience and adapt to existing store fixtures (e.g., walls, ceiling, shelving, and the like), these top-down cameras are mounted at or near the ceiling. Ceiling mounting is one option. Alternative mounts to posts, shelving, or the like are effective as long as they do not interfere with shoppers or in-store personnel operations to avoid interaction with system components. This camera configuration is preferably designed to capture images when the cart is stationary, such as near a bagging station in a checkout lane. With additional capture or processing capabilities to deal with motion and lighting, it can be used elsewhere in the store to track items added to the cart or basket while shopping. We use the terms “bagging station” and “bagging area” to mean an area at which bagging occurs. The term “station” is broadly used includes both a structure and/or an area encompassing a location at which items are transferred into bags.

The cameras and their lenses are selected to have a field of FOV that samples the scene at the resolution of the digital watermark on the item packaging, at the distance of the camera to the bottom of the cart. Naturally, this distance will vary with the retail store setting. For this illustration, we use a nominal working distance of 76 inches, and we set a target sampling resolution at this distance that corresponds to the resolution of the digital watermark applied to the surface of items (e.g., 150 elements per inch or better). At an example target 150 pixels/inch resolution, a monochrome camera with A×B pixels resolves an area of A/150 by B/150 inches. For a color camera with Bayer filtering, the effective resolution is approximately A/300 by B/300 inches.

We selected a lens with a focal length to provide the desired FOV that meets the sampling requirements described above for image capture of items in the cart. In this example, the effective focal length (EFL) of the lens is 25 mm. This is one example of the lens EFL for the sensor size of this embodiment. More generally, the lens is selected in combination with the sensor to achieve the FOV and resolution at the working distance. The EFL refers to the distance between the lens and the image sensor when the subjects within the FOV are in focus and is expressed in a measure of distance (typically, millimeters (mm)). The F-stop is selected to achieve the desired depth of field (DOF), which is the range of distance in which the subject appears sharp in the image. The F-stop is a numerical value representing the size of the aperture relative to the focal length of the lens (F-stop=Focal Length/Aperture Diameter). Larger F-stops correspond to smaller apertures, which allow less light into the camera, but have a larger DOF. Conversely, smaller F-stops correspond to larger apertures, allowing more light, but having a shallower DOF. For this example, we use a lens with an adjustable iris, and set the F-stop to F/8, balancing depth of field with expected lighting.

The camera is selected, along with the lens, to have a sensor size of sufficient dimensions, expressed in horizontal by vertical pixels, to capture an image spanning the area at the working distance within the cart at the target resolution (e.g., 150 samples/inch). Here, we selected a camera with an image sensor having a 20 MP resolution (5496×3672 pixels), with a progressive scan rolling shutter. An example of a camera having these specifications is Basler Ace model acA5472-17um from Basler Inc. Other suitable camera models can be obtained from E-Con, though there are trade-offs in the FOVs these models can achieve for the target geometry. Changes in the geometry of the environment are accommodated by selecting a camera and lens to provides a field of view fitting the geometry of the camera mounting to in-store fixtures relative to the expected cart or basket positions.

Another attribute of the camera relevant to capture of and object identification in video frames is the camera interface and its bandwidth to transfer these frames to the computing system. A USB, Gigabit Multimedia Serial Link (GMSL, GMSL2) or GigE network interface are suitable to convey frames to the computing system for image processing. In this embodiment, the computing system for image processing is a GPU-based computer, such as one that employs an NVIDIA Jetster Orin GPU-based computer or NVIDIA Jetson AGX Thor module, which includes a GPU and multicore CPUs. Alternatively, a multi-core CPU may be used. For the selected camera, frame rates of 5 to 10 frames per second are suitable. Configurations achieving higher frame rates may also be used, as explained further below, for capturing images of faster moving objects.

Another design requirement of the capture system dictated by object identification is the ability to capture color information. While monochrome capture may be sufficient for some forms of identification, including some digital watermarks, barcodes, and machine learning trained object recognition, greater identification may be achieved by leveraging color and even multi-spectral bands of the visible or near visible spectrum. The digital watermarks used for this application may be conveyed in luminance or chrominance channels. A monochrome camera is suitable for reading luminance watermarks and barcodes. Chrominance watermarks require capture of chrominance information, which may be achieved by pairing optical filter or strobed color LED illumination with a monochrome sensor, or using an RGB color camera. For example, for detecting digital watermarks visible in the red channel, we use an optical filter corresponding to this channel, e.g., a Midopt LP610 red longpass filter, which mounts to the camera via a slip mount or c mount.

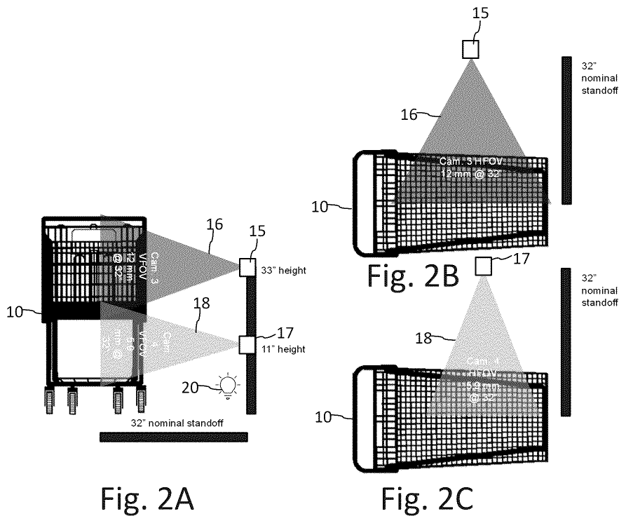

FIGS. 2A-C depict another configuration of cameras (15, 17) for capturing images of items in a shopping cart from the side. This configuration may be used in combination with the configuration of FIG. 1A to capture a side view of items in the cart and in the bottom of the cart. Reflecting this combination, the FOVs 16, 18 are labeled camera 3 and 4 (cam. 3 (15) and cam. 4 (17)), as the implementer may add these cameras to the top-down (e.g., ceiling-mounted) cameras of FIGS. 1A-C. Since the distance from the cart is closer (e.g., 32 inches), side-view cameras use different lenses to adapt the FOV for capturing images at the target resolution across the depth of field of the FOV. For example, using the same camera for camera 3 as cameras 1 and 2, we use a lens with an EFL of 12 mm. Camera 4 is a 13 MP camera from e-Con (CU135M, 13 MP monochrome camera), paired with a lens having a 5.9 mm EFL. While the in-store lighting is sufficient for the top views, the side views for the bottom of the basket benefit from diffuse fill lighting provided by light source 20. The diffuse fill lighting from light source 20, such as, e.g., LED panels emitting a neutral, white light (e.g., 4000K color temperature), enhances visibility through cart mesh without causing glare.

Though items within the cart are partially obscured by the mesh of the sidewalls of the cart, the system can read digital watermarks that are partially occluded by the mesh. The digital watermark on items is comprised of redundantly encoded tiles, each carrying an embedded identifier. A digital watermark reader reconstructs the identifier by aggregating message data from one or more tiles in the field of view of a camera.

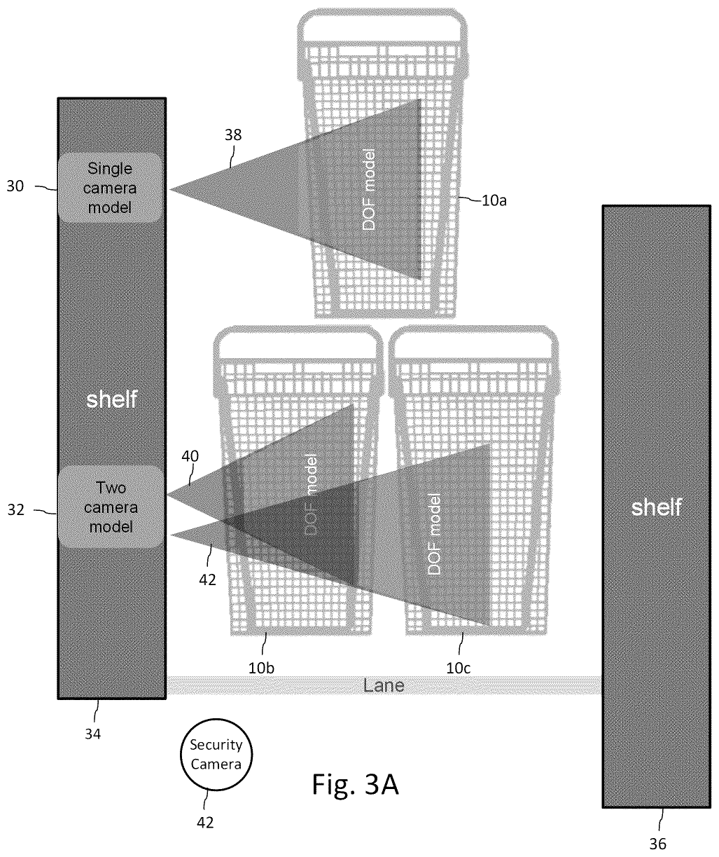

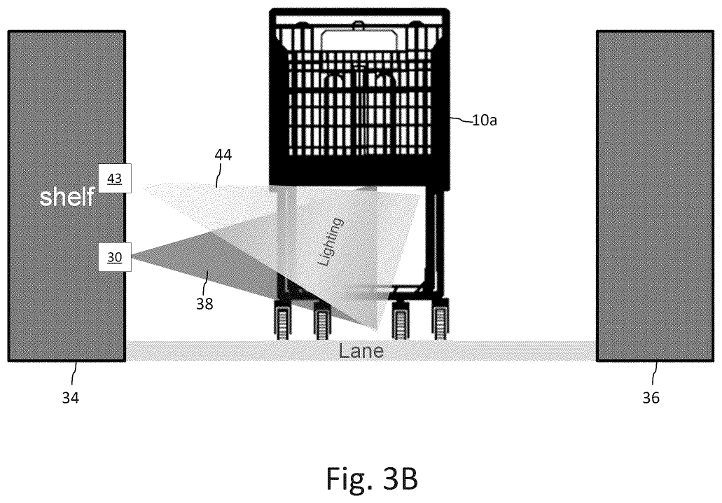

FIGS. 3A-B depict top and end views of camera configurations for capturing images of items in the bottom of a shopping cart. FIG. 3A is a top-down view of a single and two-camera configuration. FIG. 3B is an end view of a single camera configuration. In these configurations, camera models 30, 32 monitor items in carts 10a-c passing through a lane between shelves 34, 36. The single camera model 30 has a larger DOF 38 as it must cover a wider range of cart positions of a cart 10a. The two-camera model 32 has two cameras with different DOFs 40, 42, one for positions of a cart 10b closer to the camera and another for positions of a cart 10c further from the camera.

A security camera, such as security camera 42 mounted in the ceiling above the lane may be used to detect entry of the cart in the lane and determine its position using the object segmentation and recognition methods described in PCT Publication WO2024054784.

The end-view shown in FIG. 3B illustrates how the FOV and corresponding DOF 38 of the single camera configuration captures images of items in the bottom of the cart 10a. Additionally, since the items in the bottom of a cart are likely to be shaded from ceiling lighting above, bottom of basket views benefit from a diffuse fill lighting 44 from a light source 43 mounted in the shelf 34. For applications capturing images of moving objects, motion artifacts can be reduced by using strobed LED illumination synchronized (e.g., 1/30s or 1/60s) with image capture. For example, the system strobes the light source on for a period within the period when the camera shutter is open. The strobed LED illumination may comprise color LED illumination, e.g., red, blue and/or NIR illumination bands for digital watermark detection.

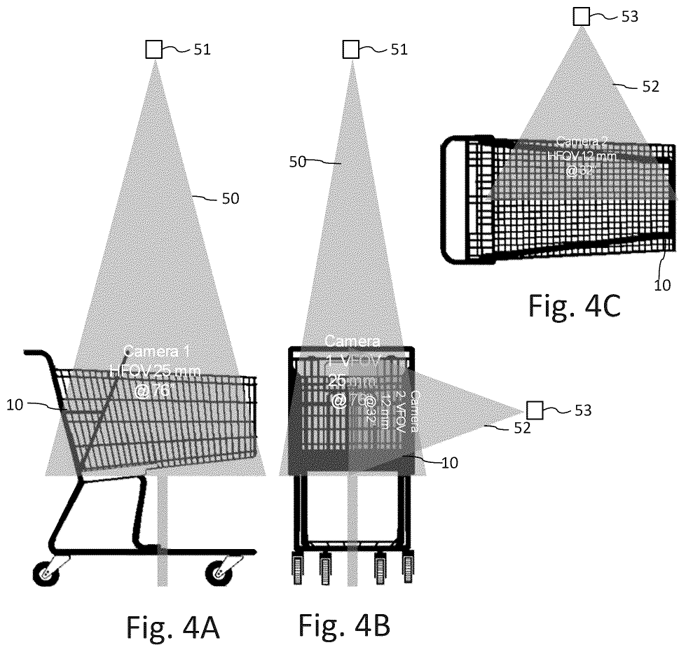

FIGS. 4A-C illustrate side, end, and top-down views of another camera configuration for capturing images of items in the shopping cart 10. This example shows the FOV 50 of a single overhead camera (camera 1 (51)), mounted on the ceiling, and the FOV 52 of a side view camera (camera 2 (53)) mounted horizontally (e.g., in a shelf, check out station or bagging area). The illustrated parameters are for the same Basler Ace camera model shown in FIG. 1, with lens parameters selected for the distance of 76 inches to the bottom of the basket for the top-down camera view (EFL 25 mm), and the distance of 32 inches from the side view camera (EFL 12 mm).

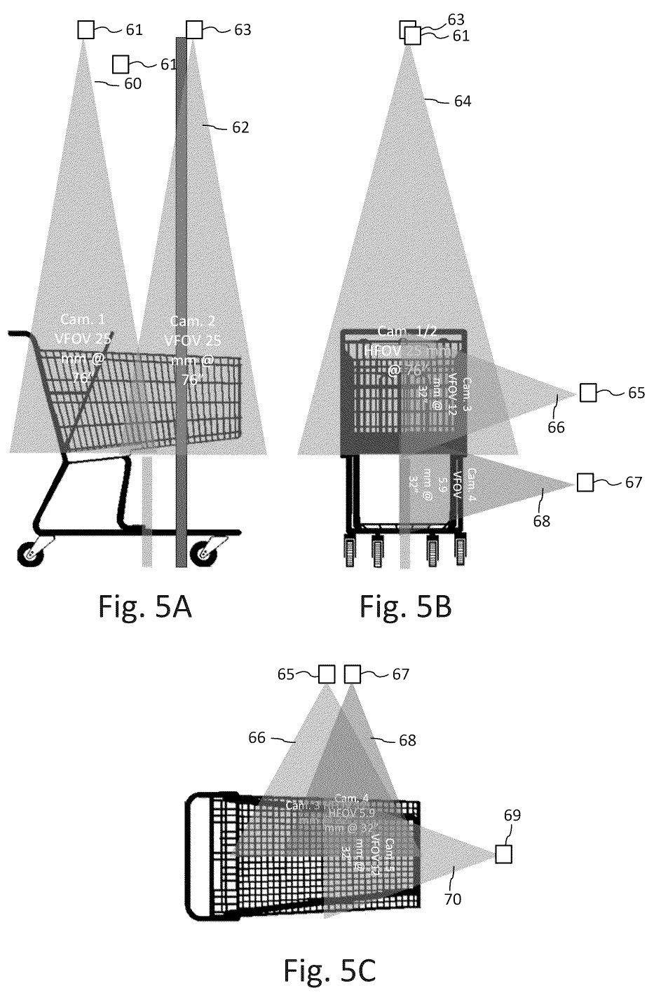

FIG. 5A-C illustrate side, end, and top-down views of another camera configuration. This variant has a similar configuration of top-down cameras of FIGS. 1A-C and side view cameras of FIGS. 2A-C. One difference is the mounting of the top-down view, directly overhead, e.g., with the direction of view of the top-down view at or near vertical, making it approximately perpendicular to the cart bottom. This is reflected in the side view of the FOVs 60, 62 of cameras 1 and 2 (61, 63). From the end view, cameras 1 and 2 have a span that covers the entire cart width as shown with FOV 64 in FIG. 5B. The horizontal mounted cameras (cam. 3 (65) and cam. 4 (67)) capture images of the side of the cart and bottom of basket, respectively. Finally, a fifth camera (cam. 5 (69)) has a FOV 70 that captures images of items at the front of the cart, including as they are moved from cart to bagging. This configuration uses the same cameras and lens pairings as described above for FIGS. 1 and 2 for cameras 1-4 and adds a fifth camera (cam. 5), like camera and lens of camera 3.

Our digital watermarks, as well as barcodes and object recognition, can identify items with geometric distortion, including a range of perspective distortion relative the plane of the 2D data carrier. Implementers, thus, set the camera view to maximize object identification within the operating envelope of the identification methods.

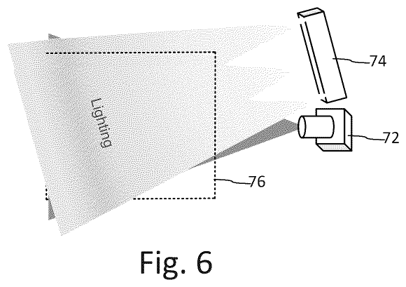

FIG. 6 illustrates a camera 72 and light bar 74 capturing images in a bagging area 76. Here, the intent is to capture images of items as the shopper moves them from a cart or basket into a bag, without manual scanning of them. As the shopper removes item from the cart, such as the front of cart depicted in the FOV 70 of camera 5 (69) in FIG. 5C, the configuration of FIG. 6 captures image frames under synchronized illumination from light bar 74. The image capture system is an adaptation of the system described in our US patent publication 20220055071, specifically its FIG. 38 and accompanying text. Light bar comprise LEDs of three distinct wavelength bands to enable reading of digital watermarks in different color channels. For example, as noted in publication 20220055071, an embodiment of the light source includes a RED LED (e.g., having a peak illumination between 620 nm-700 nm, referred to as “at or around 660 nm”), a BLUE LED (e.g., have a peak illumination between 440 nm-495 nm, referred to as “at or around 450 nm”), and a INFRARED (or Far Red) LED (e.g., having a peak illumination between 700 nm-950 nm, referred to as “at or around 730-850 nm”). To simplify the configuration, we use one light bar, rather than the two on each side of the camera show in FIG. 38 of publication 20220055071.

For reading of items in a retail environment, the frame rate may be 30 frames per second or less, with image blocks sampled from the frame at the target resolution, sized at, above or below 128 by 128 pixels per block at the target resolution, with a block overlap of 50%. The image capture and processing parameters are adjusted to accommodate the scene geometry, lighting, and available processing capability and detection requirements. In this embodiment, we adjusted the image capture parameters to fit the desired geometry of the scanning volume of bagging area 76 (e.g., an area with a depth of field and view volume spanning the bagging area 76). The camera and lighting are housed within an enclosure that shields the light from shoppers while directing it into the view volume, e.g., spanning 10-20 inches). We balanced the demands for lighting of objects with depth of field, setting the F-stop at F8. A suitable camera is the Emergent Vision HB-1800-S camera, with the Sony IMX425 image sensor, for the application described in US 20220055071. Frame rates need not be as high for retail object scanning. Suitable cameras are available, e.g., from OmniVision or Sony, and may have 8- or 12-megapixel resolution (e.g., the Sony IMX378 or IMX477), with photosensors on the order of one micron on a side.

The digital watermark reader executing within a CPU or GPU-based computer reads digital watermarks, if present, from blocks in frames in each of the color channels corresponding to the wavelength bands. It then combines the reading results from each of the channels. Through this process, the digital watermark reader provides an identifier of an object and corresponding block locations for each of the blocks and their frames in which it successfully reads a digital watermark.

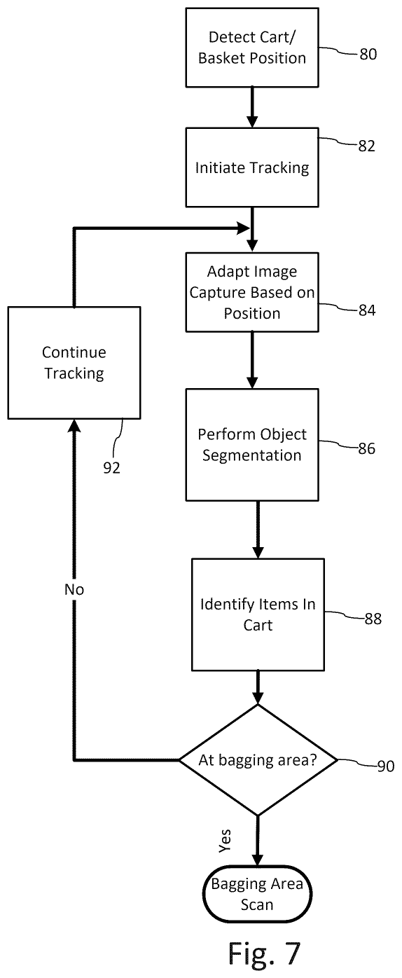

Having described various configurations for imaging items without intrusive manual scanning, we now explain methods for identifying items in these images for a frictionless checkout experience. FIG. 7 is a flow diagram illustrating a method for identifying items selected by a shopper prior to check-out. The system initiates this method when it detects the cart in the checkout area. The objective is to capture images of items in the bottom of the basket and cart, as the shopper approaches or arrives at the checkout area. This includes using shelf mounted cameras and/or ceiling mounted cameras as described above and shown in FIGS. 1-5. For example, side view cameras such as those in FIGS. 3A-B image items in the cart as it progresses down the lane.

In one embodiment, the security camera 42 captures video of the lane and sends a stream of frames to an image processing system. When the system detects entry of a cart, it detects the cart position and initiates tracking of the cart (80, 82). It detects the cart using one of the methods of object recognition described in PCT Publication WO2024054784. As an alternative, the system can employ a proximity sensor to detect activity and measure distance and trigger the camera and lighting to correspond to the position of the cart. In this case, the security camera provides complementary scene awareness regarding the presence of the cart in the lane.

By detecting the cart position, the imaging system adapts image capture to the operating envelope of the object identification methods based on that position (84). In one configuration, it selects the camera with the depth of field overlapping the cart position and executes object identification on the frames from this camera. In another configuration, it adapts the image capture for the depth of field covering the cart path by sequentially scanning the FOV through distances across the DOF (e.g., in 7 cm slices), using variable focal length capture, as described in WO2024054784. These approaches apply to various configurations, such as those depicted in FIGS. 1-5, including a configuration with a head-on camera looking through the length of the cart (e.g., FIG. 5C). One camera can act as several virtual cameras, snapping to a set of focal planes.

The image processing system executes a cart detection method to detect the cart and object segmentation to detect presence and location of objects in it (86). One approach for implementing a cart detection method is to adapt an object detection model, such as YOLO, to recognize a shopping cart and its bounding box, by training it with an annotated data set of images of shopping carts and associated bounding boxes.

Next, the image processing system uses the object segmentation approach described in PCT Publication WO2024054784 to compute masks corresponding to items in the cart, within the cart boundary. It performs this segmentation for frames within each camera view if multiple views of the cart are available. Optionally, it also merges the views into a 3D representation of the cart to enable tracking of items in a consolidated view.

The image processing system identifies items in the cart with digital watermark reading and one or more complementary identification methods (88). Complementary methods include barcode reading (e.g., UPC or QR Code reading) and object classification, using a trained classifier, e.g., a trained neural-network classifier. This process provides object identification associated with regions where the prior segmentation has located objects.

The processing of frames to locate and identify objects provides a global state of items that the system has detected in the cart prior to the shopper initiating bagging. This state then provides a reference for items that will be included in the checkout process through the scanning of items in the bagging area. Decision step 90 refers to the processing to detect the end of the pre-check out image processing of the items in the cart and transition to a checkout process at a bagging station. The process of tracking the cart and detecting items in the cart of FIG. 7 continues as shown in step 92 until the image processing system detects the cart at the bagging station. The system determines the presence of the cart at this location from the camera or cameras observing the station from the ceiling, shelving, and bagging station.

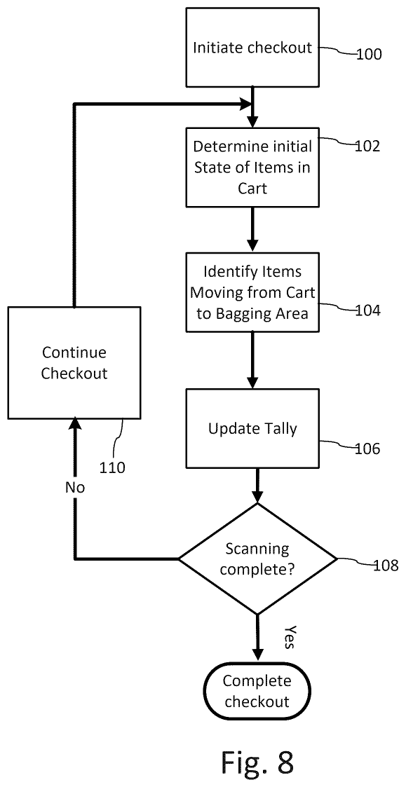

FIG. 8 is a flow diagram illustrating a method for identifying items in a bagging area for the checkout process. When the cart is detected at the bagging station via the cart detection method, the system initiates a check out process in which it determines a tally of items for the shopping transaction (100). Using the video frames captured by the camera system (e.g., configurations of embodiments in FIGS. 1-5), the image processing system determines the state of items that the system has detected in the cart prior to the shopper initiating check-out and starting to remove items from the cart (102). It makes this determination by executing the previously described object segmentation of items in each camera's view of the cart, identifying items in the regions with detected objects, and aggregating the identifying information for objects and their position within the cart from the frames captured of the cart from different cameras, including the camera viewing the bottom of basket.

From this initial state of items in the cart, the system identifies items removed from the cart from the top and side views and moved into the bagging area. With each detection, the system records items that have left the shopping cart and adds them to the tally (106). The system determines that an item is removed from the shopping cart by detecting a change in the object segmentation of the frames captured from the cameras pointed at the shopping cart. In WO2024054784, we described in detail methods for tracking object changes to support image accumulation. Here, we apply this method to detect frame to frame changes in the bounding region of an object that exceed a threshold change, indicating removal of an item from the shopping cart. The system confirms this change in state when the removed object is identified in the frames of the bagging area camera. This process continues until no more items are in the cart and the shopper has initiated payment (108, 110).

While improving the shopping experience is important to shoppers, loss prevention is critical to the retailer's bottom line. The system reduces loss by generating an alert where items detected in the cart do not appear in the final tally at checkout. This alert can be displayed on the Point-of-Sale terminal display, along with information of an item, including a picture of it. The alert can also be a message to an in-store associate to assist the shopper or checkout personnel with a quick check of the item to assess whether it was not bagged, remained in the cart, or the like.

Above, we referenced methods for cart detection, object segmentation and classification, and item identification. Here we provide additional implementation detail for these methods. The preferred method for cart detection is object classification using a trained classifier, such as the trained neural network methods disclosed in WO2024054784. This enables the image processing system to detect the cart and determine its position to optimize selection of image capture parameters for the FOV and DOF overlapping the cart position. Alternative cart detection methods may also be used. These include tracking devices, such as indoor location technology (such as tracking beacons), proximity sensor, and the like to track cart presence and movement.

For object segmentation and classification, we use the methods disclosed in WO2024054784. These include trained neural network methods, including two stage network such as Mask R-CNN, and one-stage networks, SSD (Single Shot Detector), YOLO (You Only Look Once), and RetinaNet.

For object identification, the system employs complementary identification, including digital watermarks, barcodes, and object recognition as described in WO2024054784 and U.S. Pat. No. 11,763,113. U.S. Pat. No. 11,763,113 provides a detailed description of digital watermark technology for identification of products in a retail environment. Additional details on watermark encoding and decoding are found in U.S. Pat. Nos. 6,590,996, 9,959,587, 10,242,434 and in U.S. patent publications 20190332840 and 20210299706. A commercial software development kit for implementing digital watermark reading is available from Digimarc Corporation as the Digimarc Embedded Systems SDK.

An implementation of a modular software architecture for object segmentation and identification is shown in FIG. 13 of WO2024054784 and described in the accompanying specification. To optimize use of processing resources, triggering methods described in U.S. Pat. No. 10,958,807 can be used to focus further image identification processes on regions within image frames where objects are detected.

Digital watermark encoding and decoding may employ machine learning methods to embed and read hidden identifiers on product packaging. Watermark embedding includes encoding a multi-bit message including the identifier (referred to as the payload), and inserting this encoded message into image features, which are either already present or are generated by the method (e.g., as in the case of generating signal rich art). The message encoding may be implemented using a trained channel coder, which is jointly or separately trained with other components of the watermark encoder and decoder (e.g., to optimize the watermark method for robustness and perceptual quality).

A trained neural network (NN) may be used to generate a watermark signal, which is added to an image, or may be trained to directly insert the encoded message into features in a latent space within neural network processing of a host image. In the first approach, a NN watermark generator outputs a watermark signal that is separately blended with the host image, whereas a NN watermarked signal generator is trained to generate a watermarked image. In this latter approach, the watermark may be inserted in the latent diffusion process of an image generation process (e.g., generating a watermarked image directly from an input prompt). Both types of NN systems are trained based on an input message, input training images, and loss functions. Selected based on the design requirements of the application, these loss functions can include loss functions for perceptibility, robustness (e.g., via generative adversarial network, or pre-determined signal transformations), message accuracy, and the like. These architectures are exemplary; other neural network models, such as U-Net for segmentation-integrated embedding or Vision Transformers for enhanced feature extraction, may be employed to achieve similar robustness.

These NN based components may be jointly or separately trained with other components of the watermark embedder and reader. In one embodiment, the training employs an auto-encoder-decoder architecture for the embedder, in which a neural-network is used to transform the image to a feature vector space, where the watermark signal is applied (e.g., concatenated with a feature vector), and then transformed by subsequent “decoder” layers of the auto-encoder-decoder of the watermark embedder into either a watermarked image or watermark signal, separately combined with the input image.

We use the phrase, “watermark reader” to refer to the programmed system that detects and extracts the watermark message (the “payload”) from a watermarked image. The watermark reader is distinct from the decoder component in the auto-encoder-decoder network configuration of the watermark embedder. In some embodiments, the watermark reader is programmed to detect and extract the watermark, using an implicit or explicit synchronization signal. An implicit synchronization signal is formed inherently from the message carrying component of the watermark signal. An explicit synchronization signal is an additional signal component relative to the message carrying component. Some watermark readers do not employ explicit synchronization or a synchronization step, but instead read the watermark from a domain (e.g., a feature vector space) selected or trained to be robust to an expected set of distortions, including geometric transformations, including rotation, scale changes, translation, differential scale, perspective transforms, and the like.

After synchronization, the watermark reader reverses the process of spreading the watermark over the carrier and error correction or channel coding to extract the message. The watermark reader may also be programmed by training a NN jointly with or separately from the training of the watermark embedder. For example, a ResNet architecture may be adapted and trained to detect the watermark, and to extract a watermark signal, from which the message is extracted through error correction decoding (e.g., soft decoding using a Viterbi decoder or alternative error correction or channel decoding methodology, like those noted above).

Examples of loss functions used in training the neural network watermark embedder and reader include mean squared error (MSE) or perceptual loss metrics (e.g., structural similarity index measure, SSIM, or learned perceptual image patch similarity, LPIPS) for the perceptibility loss function, which minimize visible artifacts on retail product packaging while preserving aesthetic quality. For the robustness loss function, adversarial training techniques, such as those employing diffusion-based adversarial networks or vision transformer discriminators, simulate retail-specific distortions including partial occlusions from shopping cart meshes (as shown in FIGS. 2A-C and 3A-B), motion blur from item movement (e.g., during bagging as in FIG. 6), and geometric transformations like perspective distortion from varying camera angles (e.g., top-down and side views in FIGS. 1A-C, 4A-C, and 5A-C). The message accuracy loss function employs binary cross-entropy or maximum likelihood decoding to ensure reliable extraction of a multi-bit payload, with error rates targeted below 0.5%-2% under simulated retail conditions.

Training data for the neural networks can be derived from large-scale synthetic datasets and annotated collections of retail product images, including high-resolution scans of packaging surfaces embedded with digital watermarks, augmented with physics-based distortions and neural rendering techniques to mimic real-world retail scenarios. For instance, data augmentation includes applying random crops, rotations (0-360 degrees), scale variations (0.3× to 3×), and realistic occlusion masks simulating cart wires or overlapping items, processed at resolutions matching target camera sampling (e.g., 300-600 pixels per inch as noted in para. 26). The training process utilizes backpropagation with modern optimizers such as AdamW, Lion, or Sophia, executed on distributed GPU clusters (e.g., NVIDIA Jetson AGX Thor arrays or H100 cloud instances) over epochs ranging from 100 to 500, with validation on held-out datasets of captured video frames from prototype camera configurations (e.g., FIGS. 1-6) to achieve convergence where robustness exceeds 98% detection rate in heavily occluded views.

In an exemplary implementation, a vision transformer-based auto-encoder for digital watermark embedding is trained end-to-end with a hybrid CNN-transformer reader architecture, using a combined loss that weights perceptibility, e.g., variously at 0.4-0.6, robustness at 0.2-0.4, and message accuracy at 0.1-0.3, with dynamic weighting adjusted through automated hyperparameter optimization based on retail benchmarks. This joint training, performed on frameworks like PyTorch 2.x with distributed training libraries (e.g., DeepSpeed, FairScale), enables the system to embed identifiers that are detectable in real-time during item identification flows (FIGS. 7-8), such as extracting payloads from attention-weighted regions in segmented cart images to update transaction tallies accurately, even under variable lighting from LED strobing or adaptive illumination systems.

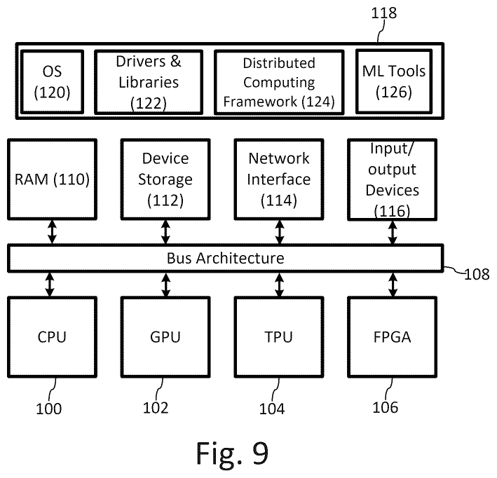

FIG. 9 is a block diagram illustrating an operating environment for components of the invention. This computing environment includes hardware and software that are useful to perform object segmentation and identification, including training and execution of machine-learning models. It is not required for all components of the system, e.g., training and application trained models are typically separate. The computers used for training and execution of the frictionless checkout systems may be single device with one or more multicore processors, as well as a distributed network of such devices.

The computing environment includes processors (e.g., multi-core processors), which include a Central Processing Unit (CPU), Graphics Processing Unit (GPU), and may also include Tensor Processing Unit or like AI accelerators (TPU), and Field Programmable Gate Arrays (FPGAs). The CPU 100 manages general computational tasks and coordinates the overall operation of the system. The CPU executes instructions, manages memory, and handles I/O operations. The GPU 102 is specialized for parallel processing. It accelerates neural-network training and inference by handling multiple calculations simultaneously. This is useful for operations such as the matrix multiplications and convolutions in the neural-networks (e.g., the visibility model and other image processing operations, including watermark reading and embedding). The TPU 104 is hardware optimized for machine learning workloads, particularly for deep learning tasks. TPUs perform tensor operations efficiently, reducing the time and power consumption for training large models. FPGA 106 is configurable hardware that can be tailored for specific neural-network architectures. FPGAs provide a balance between flexibility and performance, allowing for customization of the hardware to meet specific application needs.

The processors 100-106 are connected to and communicate with memory, storage device, a network interface via one or more bus interconnects in the bus architecture 108. The computer preferably has a high-speed bus architecture (e.g., PCIe) to interconnect the CPU 100, GPU 102, TPU 104, FPGA 106, memory (e.g., RAM 110), storage 112, network interface 114, and input/output devices 116. This architecture is designed to provide efficient data transfer and communication between components.

Memory (RAM) 110 is high-speed Random Access Memory to store active neural-network models, intermediate data, and other variables necessary for computation. Large capacity memory modules ensure that data can be quickly accessed and processed by the CPU and GPU.

Storage Device 112 are preferably solid-State Drives (SSDs) or other high-speed storage solutions to store large datasets, pretrained models, and system software. SSDs provide rapid data retrieval and write speeds, which are useful for handling extensive neural-network data.

Networking Interface 114 provides high-bandwidth network connections (e.g., 10 Gbps Ethernet, InfiniBand) to facilitate data transfer between distributed computing nodes. These interfaces enable scalable machine learning operations across multiple machines.

I/O Devices 116 include visual output devices (e.g., display monitor), audio output devices (e.g., speakers), and user input devices (e.g., keyboards, mice, touchscreens) for interaction with users of the system (e.g., shoppers, store associates, etc.).

Software Components 118 include the operating system 120, drivers and libraries 122, software for a distributed computing framework 124 and Machine Learning (ML) tools 116. The Operating System (OS) 120 manages hardware resources, provides an environment for application execution, and handles task scheduling. Examples include Linux-based systems and Microsoft Windows.

Drivers and Libraries 122 may include drivers and middleware to optimize communication between hardware components and machine learning frameworks. Examples include CUDA for NVIDIA GPUs (e.g., the Orin GPU-based computing system) and drivers for TPUs and FPGAs.

Distributed Computing Framework 124 is a framework like Apache Spark, Kubernetes, or Horovod to manage and scale machine learning tasks across multiple computing nodes. This software facilitates load balancing, fault tolerance, and efficient resource utilization.

Machine Learning (ML) tools 126 comprise software libraries such as TensorFlow, PyTorch, or MXNet, providing tools and APIs for developing, training, and deploying neural-network models. These tools enable implementation of neural-network architectures and training algorithms, such as the object segmentation, classification and identification methods described and referenced in this document.

In an exemplary configuration of the computing environment, the GPU 102, such as an NVIDIA Jetson AGX Thor module with an ARM Neoverse-V3AE CPU and up to 2,070 FP4 TFLOPS of AI performance (or NVIDIA's H100 cloud instances), is employed to accelerate parallel operations for neural network-based object segmentation and digital watermark reading on video frames captured at 5-10 frames per second from the camera configurations (e.g., as depicted in FIGS. 1A-C through 5A-C). The bus architecture 108, implemented as a PCIe 5.0 interconnect with bandwidth up to 128 GB/s, enables rapid transfer of raw video data from the network interface 114 (e.g., 25GbE or USB4 connected to cameras) to the GPU for processing, ensuring latency below 50 ms for real-time item identification during cart tracking (FIG. 7) and bagging (FIG. 8). Memory 110, configured as 128 GB LPDDR5X RAM, stores active models like Vision Transformers for segmentation (para. 53) and intermediate tensors, while the storage device 112, such as a 2 TB NVMe Gen5 SSD, hosts large datasets of annotated retail images for on-device fine-tuning of foundation models.

The software components 118 can be optimized for the retail application, with the distributed computing framework 124 (e.g., lightweight container orchestration across edge nodes) scaling workloads for high-traffic stores by distributing frame processing from bagging station cameras (FIG. 6) across available GPU resources. Machine learning tools 126, such as PyTorch 2.x with CUDA 12.x acceleration and TensorRT optimization, execute the image processing instructions to fuse outputs from complementary methods (e.g., watermark reading and barcode detection, para. 47), updating transaction tallies with accuracy exceeding 97%-99.5% in occluded views. Input/output devices 116 include point-of-sale displays for rendering alerts when discrepancies are detected, integrated via the bus architecture to provide immediate feedback to store associates. This environment provides a technological advancement by enabling cost-effective, scalable deployment in retail settings, reducing processing times for video frames by up to 75% compared to previous-generation embedded systems, as validated through benchmarks on Thor-based prototype hardware.

### Example Combinations of Features

Without limiting the scope of the appended claims, the following combinations of features are provided as non-limiting examples that demonstrate specific arrangements and aspects of the present disclosure. Of course, other combinations will be readily apparent from the written description and drawings.
A1. An apparatus for processing images in a retail item identification system, the apparatus comprising: one or more processors including a central processing unit (CPU) and a graphics processing unit (GPU), the one or more processors configured to execute image processing instructions for object segmentation and digital watermark reading; a memory coupled to the one or more processors via a bus architecture, the memory configured to store neural network models and intermediate data for the image processing instructions; a storage device coupled to the bus architecture, the storage device configured to store datasets and pretrained models; a network interface coupled to the bus architecture, the network interface configured to facilitate data transfer with external devices; and input/output devices coupled to the bus architecture, the input/output devices configured to receive video frames from a plurality of cameras and output alerts or transaction data.
A2. The apparatus of A1, wherein the one or more processors further include a tensor processing unit (TPU) optimized for machine learning workloads.
A3. The apparatus of A1, wherein the one or more processors further include a field programmable gate array (FPGA) configurable for neural network architectures.
A4. The apparatus of A1, wherein the bus architecture comprises a high-speed interconnect for data transfer between the one or more processors, the memory, the storage device, and the network interface.
A5. The apparatus of A1, wherein the memory comprises random access memory (RAM) for storing active neural network models and variables during computation.
A6. The apparatus of A1, wherein the storage device comprises a solid-state drive (SSD) for high-speed retrieval of the datasets and pretrained models.
A7. The apparatus of A1, wherein the network interface supports high-bandwidth connections for distributed computing across multiple nodes.
A8. The apparatus of A1, further comprising software components including an operating system to manage hardware resources, drivers and libraries to optimize communication with the GPU, a distributed computing framework for scaling machine learning tasks, and machine learning tools for developing and deploying neural network models.
A9. The apparatus of A1, wherein the input/output devices include a display monitor for outputting the alerts when an item detected in a shopping cart is not added to a transaction tally.
A10. The apparatus of A1, wherein the one or more processors are configured to perform the object segmentation using a trained neural network to detect bounding regions of items in the video frames.
A11. The apparatus of A1, wherein the one or more processors are configured to execute the digital watermark reading by extracting embedded identifiers from objects in the video frames, the digital watermark reading being performed in real-time on frames captured from a bagging station camera.
B1. A method for training a neural network for digital watermark embedding in a retail item identification system, the method comprising: providing input training data including a multi-bit message payload comprising an item identifier, a set of host images of retail product packaging, and loss functions including a perceptibility loss function, a robustness loss function, and a message accuracy loss function; training, using one or more processors, a neural network watermark generator based on the input training data to generate a watermark signal by inserting an encoded version of the multi-bit message payload into image features of the host images, wherein the training optimizes the neural network watermark generator to minimize the loss functions, thereby improving robustness to geometric distortions and occlusions in images captured by cameras in a retail environment; and outputting the trained neural network watermark generator for use in embedding digital watermarks on retail product packaging to enable identification of items in a shopping cart without manual scanning.
B2. The method of B1, wherein the neural network watermark generator comprises an auto-encoder-decoder architecture configured to transform a host image into a feature vector space, concatenate the encoded multi-bit message payload with a feature vector in the feature vector space, and decode the concatenated feature vector into a watermarked image or the watermark signal.
B3. The method of B1, wherein the robustness loss function incorporates predetermined signal transformations simulating occlusions from shopping cart meshes and motion blur from item movement in the retail environment.
B4. The method of B1, further comprising jointly training the neural network watermark generator with a channel coder for encoding the multi-bit message payload, wherein the channel coder is optimized to enhance error correction for watermark extraction from partially occluded images.
B5. The method of B1, wherein the trained neural network watermark generator is configured to insert the encoded multi-bit message payload into a latent space during a diffusion process for generating the watermarked image directly from an input prompt.
C1. A method for training a neural network for digital watermark reading in a retail item identification system, the method comprising: providing input training data including watermarked images of retail product packaging embedded with multi-bit message payloads comprising item identifiers, and loss functions including a robustness loss function and a message accuracy loss function; training, using one or more processors, a neural network watermark reader based on the input training data to detect and extract the multi-bit message payloads from the watermarked images, wherein the training optimizes the neural network watermark reader to minimize the loss functions, thereby improving detection accuracy in the presence of geometric distortions and occlusions in video frames captured by cameras positioned to view a shopping cart; and outputting the trained neural network watermark reader for use in identifying items in the video frames during a frictionless retail checkout process.
C2. The method of C1, wherein the neural network watermark reader comprises a ResNet architecture trained to detect an implicit synchronization signal formed from a message-carrying component of a watermark signal and extract the multi-bit message payload through error correction decoding.
C3. The method of C1, wherein the robustness loss function incorporates generative adversarial network techniques to simulate distortions including rotation, scale changes, and perspective transforms encountered in retail camera configurations.
C4. The method of C1, further comprising jointly training the neural network watermark reader with a neural network watermark generator, wherein the joint training optimizes end-to-end watermark embedding and reading for retail applications.
D1. A system for identifying items in a retail environment using a trained neural network for digital watermark processing, the system comprising: a plurality of cameras configured to capture video frames of items in a shopping cart; one or more processors including a graphics processing unit (GPU), the one or more processors coupled to the plurality of cameras and configured to: execute a trained neural network watermark generator, trained using loss functions including perceptibility, robustness, and message accuracy, to embed a multi-bit message payload comprising an item identifier into image features of product packaging, generating watermarked packaging resistant to occlusions; and execute a trained neural network watermark reader, trained using the loss functions, to extract the multi-bit message payload from the video frames, wherein the extracted payload updates a transaction tally for a frictionless checkout; and a display device configured to output an alert when an item detected in the shopping cart is not added to the transaction tally based on the extracted payload.
D2. The system of D1, wherein the trained neural network watermark embedder comprises an auto-encoder-decoder architecture that transforms a host image of the product packaging into a feature vector space and inserts an encoded version of the multi-bit message payload into the feature vector space.
D3. The system of D1, wherein the trained neural network watermark reader is configured to detect the multi-bit message payload from a feature vector space robust to geometric transformations in the video frames.
D4. The system of D1, wherein the one or more processors are further configured to perform object segmentation on the video frames using a trained neural network classifier, and apply the trained neural network watermark reader to bounding regions identified by the object segmentation.
E1. A non-transitory computer-readable medium having instructions stored thereon that, when executed by one or more processors, cause the one or more processors to perform operations comprising: capturing, by a first camera and a second camera, video frames of a shopping cart from different perspectives; capturing, by a bagging station camera, video frames of items moving from the shopping cart to a bagging station; performing object segmentation and digital watermark reading of objects detected in the object segmentation from the video frames captured by the first and second cameras; identifying items in the video frames from the bagging station camera as the items move from the shopping cart to the bagging station; sensing the items removed from the shopping cart; and updating a tally of the items for a shopping transaction upon sensing the items removed from the shopping cart and moved to the bagging station.
E2. The non-transitory computer-readable medium of E1, wherein performing the object segmentation comprises separating individual items from the video frames of the shopping cart captured by the first and second cameras by executing a trained neural network classifier to detect a bounding region of an object in frames from each camera, and comparing the bounding regions detected from the first and second cameras to resolve overlapping objects and assess whether one or more objects reside within bounding regions that overlap.
E3. The non-transitory computer-readable medium of E1, wherein performing the digital watermark reading comprises extracting embedded information from the objects detected in the object segmentation to assist in identifying the items.
F1. A non-transitory computer-readable medium having instructions stored thereon that, when executed by one or more processors, cause the one or more processors to perform operations comprising: capturing, by a plurality of cameras including first and second cameras, video frames of a shopping cart from different perspectives; capturing, by a bagging station camera, video frames of items moving from the shopping cart to a bagging station; performing object segmentation and digital watermark reading of items detected in the object segmentation from frames of video captured by the first and second cameras; identifying items in video frames from the bagging station camera as items move from the shopping cart to the bagging station; and updating a tally of items for a shopping transaction upon sensing items removed from the shopping cart.
F2. The non-transitory computer-readable medium of F1, wherein the operations further comprise detecting removal of items from the shopping cart by detecting a change in a bounding region identified by the object segmentation from video frames of the shopping cart and reading a digital watermark or barcode of a removed item from a video frame captured of the bagging station with the bagging station camera.
F3. The non-transitory computer-readable medium of F1, wherein the operations further comprise generating an alert when an item is removed from the shopping cart without being identified.
G1. A non-transitory computer-readable medium having instructions stored thereon that, when executed by one or more processors, cause the one or more processors to perform operations comprising: providing input training data including a multi-bit message payload comprising an item identifier, a set of host images of retail product packaging, and loss functions including a perceptibility loss function, a robustness loss function, and a message accuracy loss function; training a neural network watermark generator based on the input training data to generate a watermark signal by inserting an encoded version of the multi-bit message payload into image features of the host images, wherein the training optimizes the neural network watermark generator to minimize the loss functions, thereby improving robustness to geometric distortions and occlusions in images captured by cameras in a retail environment; and outputting the trained neural network watermark generator for use in embedding digital watermarks on retail product packaging to enable identification of items in a shopping cart without manual scanning.
G2. The non-transitory computer-readable medium of G1, wherein the neural network watermark generator comprises an auto-encoder-decoder architecture configured to transform a host image into a feature vector space, concatenate the encoded multi-bit message payload with a feature vector in the feature vector space, and decode the concatenated feature vector into a watermarked image or the watermark signal.
G3. The non-transitory computer-readable medium of G1, wherein the robustness loss function incorporates predetermined signal transformations simulating occlusions from shopping cart meshes and motion blur from item movement in the retail environment.
H1. A non-transitory computer-readable medium having instructions stored thereon that, when executed by one or more processors, cause the one or more processors to perform operations comprising: providing input training data including watermarked images of retail product packaging embedded with multi-bit message payloads comprising item identifiers, and loss functions including a robustness loss function and a message accuracy loss function; training a neural network watermark reader based on the input training data to detect and extract the multi-bit message payloads from the watermarked images, wherein the training optimizes the neural network watermark reader to minimize the loss functions, thereby improving detection accuracy in the presence of geometric distortions and occlusions in video frames captured by cameras positioned to view a shopping cart; and outputting the trained neural network watermark reader for use in identifying items in the video frames during a frictionless retail checkout process.
H2. The non-transitory computer-readable medium of H1, wherein the neural network watermark reader comprises a ResNet architecture trained to detect an implicit synchronization signal formed from a message-carrying component of a watermark signal and extract the multi-bit message payload through error correction decoding.
H3. The non-transitory computer-readable medium of H1, wherein the robustness loss function incorporates generative adversarial network techniques to simulate distortions including rotation, scale changes, and perspective transforms encountered in retail camera configurations.
I1. A camera system for capturing images of items in a shopping cart in a retail environment, the camera system comprising: at least one top-down camera mounted above the shopping cart and configured to capture video frames of the items in the shopping cart from a top-down perspective, the at least one top-down camera having a lens with an effective focal length selected to provide a field of view spanning at least a portion of the shopping cart at a target resolution sufficient for digital watermark detection; at least one side-view camera mounted to a side of the shopping cart path and configured to capture video frames of the items in the shopping cart from a side perspective, including items in a bottom of the shopping cart; and a lighting source configured to provide illumination synchronized with frame capture by the at least one side-view camera, wherein the lighting source reduces shading in the bottom of the shopping cart.
I2. The camera system of I1, wherein the at least one top-down camera comprises a first top-down camera with a field of view spanning a front section of the shopping cart and a second top-down camera with a field of view spanning a back section of the shopping cart.
I3. The camera system of I1, wherein the at least one side-view camera is shelf-mounted and configured to capture images through a mesh sidewall of the shopping cart, and wherein the lighting source comprises a diffuse fill light mounted in a shelf to enhance visibility through the mesh.
I4. The camera system of I1, further comprising a security camera configured to detect a position of the shopping cart, wherein image capture parameters of the at least one side-view camera are adapted based on the detected position to overlap a depth of field with the shopping cart.
I5. The camera system of I1, wherein the lighting source comprises strobed LED illumination in multiple wavelength bands, including red, blue, and infrared, synchronized with frame capture to reduce motion artifacts.
J1. A method for tracking and identifying items in a shopping cart prior to a retail checkout process, the method comprising: detecting a position of the shopping cart using a security camera or proximity sensor; initiating tracking of the shopping cart based on the detected position; adapting image capture parameters of one or more cameras based on the position to optimize a field of view and depth of field overlapping the shopping cart; capturing video frames of the shopping cart from the one or more cameras; performing object segmentation on the video frames to detect bounding regions of items in the shopping cart; and identifying the items by reading digital watermarks from the bounding regions to establish an initial state of items in the shopping cart.
J2. The method of J1, wherein detecting the position comprises executing a trained object detection model on frames from the security camera to recognize the shopping cart and determine its bounding box.
J3. The method of J1, wherein adapting the image capture parameters comprises selecting a camera from a plurality of cameras having a depth of field corresponding to the position or sequentially scanning focal planes across the depth of field using variable focal length capture.
J4. The method of J1, further comprising merging the video frames from multiple camera perspectives into a three-dimensional representation of the shopping cart to track item positions.
J5. The method of J1, wherein identifying the items further comprises applying complementary identification methods, including barcode reading and object classification using a trained neural network, and aggregating identification results across the video frames.
J6. The method of J1, further comprising continuing the tracking until the shopping cart is detected at a bagging station, and transitioning to identifying items moving to the bagging station.
K1. A system for loss prevention in a retail checkout process, the system comprising:
an image processing system configured to: determine an initial state of items in a shopping cart based on video frames captured prior to checkout; track removal of items from the shopping cart to a bagging area during checkout; update a transaction tally based on items identified in the bagging area; compare the initial state of items with the transaction tally to detect discrepancies; and generate an alert upon detecting a discrepancy, the alert including a display of information about an unmatched item, including an image of the item captured from the video frames.
K2. The system of K1, wherein the alert is displayed on a point-of-sale terminal or transmitted to a device of an in-store associate.
K3. The system of K1, wherein detecting the discrepancy comprises identifying an item in the initial state that is not added to the transaction tally after removal from the shopping cart.
K4. The system of K1, integrated into the system of K1, wherein the initial state is determined using digital watermark reading on occluded items visible through a mesh of the shopping cart.
L1. A method for identifying occluded items in a retail environment using digital watermarks, the method comprising: capturing video frames of items in a shopping cart, wherein at least a portion of an item is occluded by a mesh of the shopping cart or other objects; performing object segmentation on the video frames to detect bounding regions of the items; reading a digital watermark from a visible portion within a bounding region, the digital watermark comprising redundantly encoded tiles each carrying an item identifier; and reconstructing the item identifier by aggregating data from one or more of the tiles, even when only a partial view of the item is available.
L2. The method of L1, wherein the digital watermark is conveyed in luminance or chrominance channels, and reading the digital watermark comprises capturing chrominance information using color cameras or optical filters paired with monochrome sensors.
L3. The method of L1, further comprising combining the reconstructed item identifier with results from complementary methods, including barcode reading and object recognition, to confirm item identity.
M1. A method for identifying items for a retail checkout process, comprising: capturing, by a plurality of cameras including first and second cameras, video frames of a shopping cart from different perspectives; capturing, by a bagging station camera, video frames of items moving from the shopping cart to a bagging station; performing, by an image processing system coupled to the plurality of cameras, object segmentation and digital watermark reading of items detected in the object segmentation from frames of video captured by the first and second cameras; identifying, by the image processing system, items in video frames from the bagging station camera as items move from the shopping cart to the bagging station; and updating, by the image processing system, a tally of items for a shopping transaction upon sensing items removed from the shopping cart.
M2. The method of M1, wherein capturing video frames of the shopping cart comprises capturing multiple camera views and angles of the shopping cart using top-down and side view cameras.
M3. The method of M1, wherein capturing video frames of items moving from the shopping cart to the bagging station comprises capturing a camera view of the items moving between the shopping cart and the bagging station using the bagging station camera.
M4. The method of M1, wherein identifying items in video frames comprises performing object segmentation and digital watermark reading.
M5. The method of M1, further comprising detecting removal of items from the shopping cart by detecting a change in a bounding region identified by the object segmentation from video frames of the shopping cart and reading a digital watermark or barcode of a removed item from a video frame captured of the bagging station with the bagging station camera.
M6. The method of M1, further comprising positioning the plurality of cameras at different locations to capture various views of the shopping cart and the bagging station.
M7. The method of M1, wherein performing object segmentation and digital watermark reading comprises processing the video frames in real-time.
M8. The method of M1, further comprising generating an alert when an item is removed from the shopping cart without being identified.
M9. The method of M1, further comprising storing the tally of items for the shopping transaction in association with a customer identifier.
N1. A system for identifying items for a retail checkout process, comprising: a plurality of cameras including top-down and side view cameras for capturing video frames of a shopping cart and a bagging station camera for capturing video frames of items moving from the shopping cart to a bagging station; an image processing system coupled to the plurality of cameras, the image processing system comprising a computer configured with instructions to: perform object segmentation and digital watermark reading of items detected in the object segmentation from frames of video captured by the top-down and side view cameras; identify items in video frames from the bagging station camera as items move from the shopping cart to the bagging station; and update a tally of items for a shopping transaction upon sensing items removed from the shopping cart.
N2. The system of N1, wherein the top-down and side view cameras provide multiple camera views and angles of the shopping cart.
N3. The system of N1, wherein the bagging station camera provides a camera view of items moving between the shopping cart and the bagging station.
N4. The system of N1, wherein the image processing system applies digital watermark reading, barcode reading, and object classification with a trained neural network classifier to detect and identify the items in the video frames.
N5. The system of N1, wherein the computer is further configured to detect removal of items from the shopping cart to update the tally of items based on detecting a change in bounding regions of items in the shopping cart and detection of digital watermarks in items removed from the shopping cart.
N6. The system of N1, wherein the plurality of cameras are positioned at different locations to capture various views of the shopping cart and the bagging station.
N7. The system of N1, wherein the image processing system is configured to process the video frames in real-time.
N8. The system of N1, wherein the computer is further configured to generate an alert when an item is removed from the shopping cart without being identified.

### CONCLUSION

It will be appreciated that references herein to particular commercial products, such as cameras, lenses, image sensors, GPUs, and other components (e.g., those available from Basler, e-Con, Sony, NVIDIA, OmniVision, Emergent Vision, and the like), are provided as illustrative examples to demonstrate workable implementations. Such references are not intended to be limiting, and the inventive subject matter encompasses alternatives, equivalents, and successors to these specific commercial products. One of ordinary skill in the art will recognize that other suitable components may be substituted without departing from the scope of the claimed invention.

To provide a comprehensive disclosure, while complying with the Patent Act's requirement of conciseness, applicant incorporates-by-reference each of the documents referenced herein. Such materials are incorporated in their entireties, even if cited above in connection with specific of their teachings. These references disclose technologies and teachings that applicant intends be incorporated into the arrangements detailed herein, and into which the technologies and teachings presently-detailed may be incorporated.

Having described and illustrated the principles of the technology with reference to specific implementations, it will be recognized that the technology can be implemented in many other, different, forms. The particular combinations of elements and features in the above-detailed embodiments are exemplary; the interchanging and substitution of these teachings with other teachings in this and the incorporated-by-reference patents/applications are also contemplated.

1. A system for identifying items for a retail checkout process, the system comprising:
a plurality of cameras including at least a first camera and a second camera, and a bagging station camera, wherein the first camera and the second camera are configured to capture video frames of a shopping cart from different perspectives, and the bagging station camera is configured to capture video frames of items moving from the shopping cart to a bagging station;
an image processing system coupled to the plurality of cameras, the image processing system comprising a computer configured with instructions to:
perform object segmentation and digital watermark reading of objects detected in the object segmentation from frames of video captured by the first camera and the second camera;
identify items in video frames from the bagging station camera as the items move from the shopping cart to the bagging station; and
update a tally of items for a shopping transaction upon sensing the items removed from the shopping cart; and
wherein the system updates the tally of items for the shopping transaction upon sensing the items removed from the shopping cart and moved to the bagging station.

2. The system of claim 1, wherein the first camera and the second camera comprise a top-down camera and a side-view camera positioned above and to a side of the shopping cart, respectively, to capture the video frames of the shopping cart from different angles.

3. The system of claim 1, wherein the bagging station camera is positioned to capture the video frames of the items as the items are moved from the shopping cart and placed in a bag at the bagging station.

4. The system of claim 2, wherein the image processing system is further configured to detect items as the items move from the shopping cart to the bagging station using the video frames captured by the top-down camera or the side-view camera.

5. The system of claim 1, further comprising a lighting apparatus that emits strobed illumination in at least two wavelength bands, the strobed illumination being synchronized with frame capture of the frames captured by the bagging station camera.

6. The system of claim 1, wherein the object segmentation performed by the image processing system separates individual items from the video frames of the shopping cart captured by the first camera and the second camera.

7. The system of claim 1, wherein the digital watermark reading performed by the image processing system extracts embedded information from the objects detected in the object segmentation to assist in identifying the items.

8. The system of claim 1, wherein the computer is further configured with instructions to identify items in the video frames from the bagging station camera by executing a trained neural network classifier on objects detected in the object segmentation.

9. The system of claim 1, wherein sensing the items removed from the shopping cart comprises detecting a change in a bounding region of an object previously detected by object segmentation.

10. The system of claim 1, wherein sensing the items removed from the shopping cart and moved to the bagging station comprises detecting the items in the bagging station based on the video frames captured by the bagging station camera.

11. The system of claim 1, wherein updating the tally of items for the shopping transaction comprises incrementing a count of each identified item as it is sensed being removed from the shopping cart and moved to the bagging station.

12. A method for identifying items for a retail checkout process, the method comprising:
capturing, by a first camera and a second camera, video frames of a shopping cart from different perspectives;
capturing, by a bagging station camera, video frames of items moving from the shopping cart to a bagging station;
performing, by an image processing system coupled to the first camera and the second camera, and the bagging station camera, object segmentation and digital watermark reading of objects detected in the object segmentation from the video frames captured by the first camera and the second camera;
identifying, by the image processing system, items in the video frames from the bagging station camera as the items move from the shopping cart to the bagging station;
sensing, by the image processing system, the items removed from the shopping cart; and
updating, by the image processing system, a tally of the items for a shopping transaction upon sensing the items removed from the shopping cart and moved to the bagging station.

13. The method of claim 12, wherein the first camera and the second camera comprises a top-down camera and a side view camera that capture the video frames of the shopping cart from above and from a side, respectively.

14. The method of claim 12, wherein the bagging station camera captures the video frames of the items as the items are moved from the shopping cart and placed in the bagging station.

15. The method of claim 12, further comprising tracking, by the image processing system, the items as they move from the shopping cart to the bagging station using the video frames captured by the bagging station camera.

16. The method of claim 12, wherein performing the object segmentation comprises separating individual items from the video frames of the shopping cart captured by the first camera and the second camera by executing a trained neural network classifier to detect a bounding region of an object in frames from each camera, and comparing a first bounding region detected from the first camera and a second bounding region detected from the second camera to resolve overlapping objects by assessing whether one or more objects reside within bounding regions that overlap.

17. The method of claim 12, wherein performing the digital watermark reading comprises extracting embedded information from the objects detected in the object segmentation to assist in identifying the items.

18. The method of claim 12, wherein said identifying, by the image processing system, items in the video frames from the bagging station camera comprises executing a trained classifier to classify the items, the trained classifier being trained to identify items from images captured of products.

19. The method of claim 12, wherein sensing the items removed from the shopping cart comprises detecting a decrease in a number of items present in the shopping cart based on the video frames captured by at least one of a top-down camera or a side view camera.

20. The method of claim 12, wherein sensing the items removed from the shopping cart and moved to the bagging station comprises detecting the items being placed in the bagging station based on the video frames captured by the bagging station camera.
